(19) United States
(12) Patent Application Publication
(10) Pub. No.: US 2010/0116731 A1
(43) Pub. Date: May 13, 2010

(54) Reverse Osmosis Water Purifier Having Simple Filter Configuration

(75) Inventors: Jeong-Yul Kim, Seoul (KR); Sang-Ok Moon, Daegu (KR); Sung-Pyo Hong, Gumi-si (KR); Yong-Doo Jung, Paju-si (KR)

Correspondence Address: REINHART BOERNER VAN DEUREN P.C., 2215 PERRYGREEN WAY, ROCKFORD, IL, 61107, US

(73) Assignee: Woongjin Chemical Co., Ltd., Gumi-si (KR)

(21) Appl. No.: 12/614,068

(22) Filed: Nov. 6, 2009

(30) Foreign Application Priority Data
Nov. 11, 2008 (KR) 10-2008-111887
Nov. 2, 2009 (KR) 10-2009-104979

(51) Int. Cl. B01D 71/56; C02F 1/44

(52) U.S. Cl. 210/257.2; 210/259

(57) ABSTRACT

Disclosed therein is a reverse osmosis water purifier having a simple filter configuration, which includes filter parts consisted of a sediment-filter, a chlorine-resistant polyamide composite membrane and a post-carbon-filter. The reverse osmosis water purifier can be designed in slim size by omitting a pre-carbon-filter, and provide drinking water of good quality since a portion of the residual chlorine in the feed water pass through the chlorine-resistant polyamide composite membrane to the downstream of said membrane and the residual chlorine can inhibit an adventitious growth of microorganism in the post-carbon-filter or the purified-water tank.

### CROSS-REFERENCE TO RELATED PATENT APPLICATIONS

This patent application claims priority to Korean Patent Application No. 2008-111887, filed on Nov. 11, 2008, and Korean Patent Application No. 2009-104979, filed on Nov. 2, 2009, the entire teachings and disclosure of which are incorporated herein by reference thereto.

### BACKGROUND OF THE INVENTION

It is known that dissolved substances can be separated from water by the use of various type of selective membranes, such selective membranes including reverse osmosis membranes, ultrafiltration membranes and microfiltration membranes in order of increasing pore size. A typical polyamide composite reverse osmosis membrane has a pore size of 0.001 μM on the surface thereof to show removal efficiency of more than 90% against ionic salts, heavy metals, organic and inorganic pollutants, and to remove more than 99% of bacteria and viruses. Therefore, reverse osmosis water purifiers containing a polyamide composite membrane is becoming more attractive in the water purifier industry.

The schematic drawing of FIG. 3 shows a conventional reverse osmosis water purifier consisted of an intake valve 1, a sediment-filter 2, a pre-carbon-filter 9, a pressure pump 8, a polyamide composite membrane 10, a post-carbon filter 4, a backflow prevention valve (no drawing), a water storage tank 7 and a check valve 5.

The sediment-filter 2 serves to remove suspended solids, sand, rust and moss from raw water, and the pre-carbon-filter 9 serves to remove volatile organic compounds, pesticides and, most importantly residual chlorine to prevent the polyamide composite membrane 10 from being oxidized and degraded by the residual chlorine. The polyamide composite membrane 10 serves to filter ionic salts, organic and inorganic pollutants, bacteria, viruses, and heavy metals in the feed water, and the post-carbon filter 4 serves to remove gas and compounds causing bad smell and taste.

The aforementioned conventional reverse osmosis water purifier may have difficulty in fitting in a small space due to its bulky size since it carries four filters.

Furthermore, the conventional reverse osmosis water purifier could cause difficulty in replacing the filters due to its crowded filter connections, especially when end users try by themselves to replace the old filters.

To overcome the problems in dealing with the bulkiness of the reverse osmosis water purifier, Korean Patent Application Nos. 2004-0042180, 2004-0042181 and 2005-0022694 disclose reverse osmosis water purifiers reduced in size, wherein a sediment-filter and a pre-carbon-filter are reduced in size and combined as one composite filter. The composite filter, a polyamide composite membrane and a post-carbon filter are constructed in one filter case to reduce the size of the purifier.

However, the reduction in size of the pre-carbon-filter can shorten its lifespan in protecting the polyamide composite membrane from chlorine, trihalomethane (THM), and fouling organic substance.

Especially, the residual chlorine must be removed by the pre-carbon-filter. A decrease in the chlorine removal efficiency of the pre-carbon-filter would increase a chance for the residual chlorine to pass the filter and contact the polyamide composite membrane to result in degradation of the membrane. The damaged membrane would pass hazardous substance to the permeate to yield contaminated drinking water.

Although the polyamide membrane stops all the microorganisms and pathogens, there could be adventitious growth of microorganism in the post-carbon filter and the product water storage tank. In this regard, some residual chlorine is desirable in the downstream of the membrane.

### SUMMARY OF THE INVENTION

Accordingly, the present invention has been made in an effort to solve the aforementioned problems experienced in the prior arts, and it is an object of the present invention to provide a reverse osmosis water purifier having a simple filter configuration consisted of a sediment filter a chlorine-resistant polyamide composite membrane, and a post-carbon filter without the need of a pre-carbon-filter.

A pre-carbon filter is necessary for a regular polyamide reverse osmosis membrane to be protected from degradation caused by chlorine in feed water. Thus, it is another object of the present invention to embody the use of a chlorine-resistant polyamide membrane in the water purifier, not only to eliminate the need of a pre-carbon filter, but also to allow chlorine to pass through the membrane and to disinfect the downstream of the membrane including the post-carbon-filter and a reservoir of the purified water.

The reverse osmosis water purifier comprises filter parts connected sequentially, said filter parts being consisted of a sediment-filter, a chlorine-resistant polyamide composite membrane, and a post-carbon filter; and a tank storing the purified water.

The chlorine-resistant polyamide composite membrane is obtained from alkylating a polyamide composite membrane.

An alkylating agent is at least one selected from the group consisted of dimethylsulfate, methyl iodide, methyl bromide, ethyl iodide, ethyl bromide, propyl iodide, propyl bromide, allyl iodide, allyl bromide, allyl chloride, ethylene diiodide, ethylene dibromide trimethylene diiodide, and trimethylene dibromide.

Said chlorine-resistant polyamide composite membrane shows chlorine resistance to keep a desalination efficiency of at least 85% when it is contacted with sodium hypochlorite (NaOCl) in a concentration of 500 ppm for 24 hours or 2,000 ppm for 1 hour or 2 ppm for 1,000 hours.

And the permeate flux of the chlorine-resistant polyamide composite membrane is 10 GFD or more when the chlorine-resistant polyamide composite membrane is tested using 250 ppm of NaCl at 60 psi.

Moreover, the chlorine-resistant polyamide composite membrane passes 20% or more of the residual chlorine in the feed water.

It is yet another object to provide a reverse osmosis water purifier consisted of a sediment-filter, a chlorine-resistant polyamide composite membrane and a post-carbon-filter, being simplified in structure of the filter housing by omitting a pre-carbon-filter, and being able to inhibit an adventitious growth of microorganisms due to chlorine permeated from the membrane to the post-carbon-filter and the purified-water tank, whereby the reverse osmosis water purifier provides high quality drinking water, cost-effectively using fewer filters and space-saving fashion due to its slim size.

### DESCRIPTION OF DRAWINGS

FIG. 1 is a schematic diagram of a reverse osmosis water purifier comprising a sediment-filter 2, a chlorine-resistant polyamide composite membrane 3, a post-carbon filter 4 and a purified-water tank 7 according to a preferred embodiment of the present invention.

FIG. 2 is a schematic diagram of a reverse osmosis water purifier comprising a sediment-filter 2, a chlorine-resistant polyamide composite membrane 3, a purified-water tank 7 and a post-carbon filter 4 according to another preferred embodiment of the present invention.

FIG. 3 is a schematic diagram of a conventional reverse osmosis water purifier.

### DESCRIPTION OF REFERENCE NUMERALS IN THE DRAWINGS

1: intake valve
2: sediment-filter
3: chlorine-resistant polyamide composite membrane
4: post-carbon filter
5: water control valve
6: wastewater pipe
7: purified-water tank
8: pressure pump
9: pre-carbon-filter
10: regular polyamide composite membrane

### DETAILED DESCRIPTION OF PREFERRED EMBODIMENTS

The present invention provides a reverse osmosis water purifier having a simple filter configuration, said reverse osmosis water purifier comprising filter parts consisted of a sediment-filter 2, a chlorine-resistant polyamide composite membrane 3, and a post-carbon-filter 4, wherein the chlorine-resistant polyamide composite membrane does not need a pre-carbon filter in the same way as a regular polyamide composite membrane of the conventional reverse osmosis water purifier needs a pre-carbon filter to protect it from chlorine in the feed water, thus making it possible to omit a pre-carbon filter to simplify the configuration of the filter parts.

The chlorine-resistant polyamide composite membrane according to the present invention is not damaged by chlorine contained in the feed water. For an example, the polyamide composite membrane of the present invention showed chlorine resistance by maintaining a desalination efficiency of at least 85% when it is tested using sodium chloride (NaCl) in a concentration of 2,000 ppm at a pressure of 225 psi after being exposed to sodium hypochlorite (NaOCl) in a concentration of 500 ppm for 24 hours or 2,000 ppm for one hour. In another example, it exhibits chlorine resistance by keeping a desalination efficiency of at least 85% when it is tested using sodium chloride (NaCl) in a concentration of 250 ppm at a pressure of 60 psi after being exposed to a residual chlorine concentration of 2 ppm for 1,000 hours.

Moreover, the chlorine-resistant polyamide composite membrane produce a flux of 10 GFD (gallon·ft²/day) or more when the chlorine-resistant polyamide composite membrane is tested using sodium chloride (NaCl) in a concentration of 250 ppm at a pressure of 60 psi.

In the present invention, the chlorine-resistant polyamide composite membrane is obtained through the conventional method of producing a polyamide composite membrane and a post-treatment comprising the steps of: coating a porous support with a poly functional amine solution, removing excess of the solution from the support; contacting said amine solution on the support with an organic solution containing a polyfunctional acyl halide, a polyfunctional sulfonyl halide or a polyfunctional isocyanate to make a polyamide interfacially on the support; and the resulting polyamide membrane being subjected to an alkylation step.

Said alkylation step comprises a step of immersing the polyamide membrane formed on the porous support in a solution containing an alkylating agent at pH 11 to 13 at a temperature ranging from room temperature to 80° C. to thereby replace a hydrogen group in an amide linkage (—NHCO—) of the polyamide with an alkyl group and generate an alkylated amide linkage (—NRCO—). Therefore, since the hydrogen of the amide linkage (—NHCO—) being reactive with chlorine is replaced with an alkyl group, the polyamide composite membrane becomes mush less reactive to chlorine to give greatly improved chlorine resistant property. The alkylation step can be carried out under a pressure ranging from 10 to 800 psi in a pressure vessel using a module.

An alkylating agent may be at least one selected from a group consisted of dimethylsulfate, methyl iodide, methyl bromide, ethyl iodide, ethyl bromide, propyl iodide, propyl bromide, allyl iodide, allyl bromide, allyl chloride, ethylene diiodide, ethylene dibromide, trimethylene diiodide, and trimethylene dibromide.

Furthermore, while the chlorine-resistant polyamide composite membrane exerts excellent chlorine resistance, it can also pass some residual chlorine contained in the feed (tap) water, preferably, at least 20% of the residual chlorine, and more preferably, more than 30% to the downstream of the membrane to thereby inhibit a growth potential of microorganisms in the post-carbon-filter or the purified-water tank.

If the permeability of the residual chlorine through the membrane is less than 20% of the tap water having 2 ppm chlorine, the residual chlorine would not be enough to kill microorganisms in the post-carbon-filter or the purified-water tank.

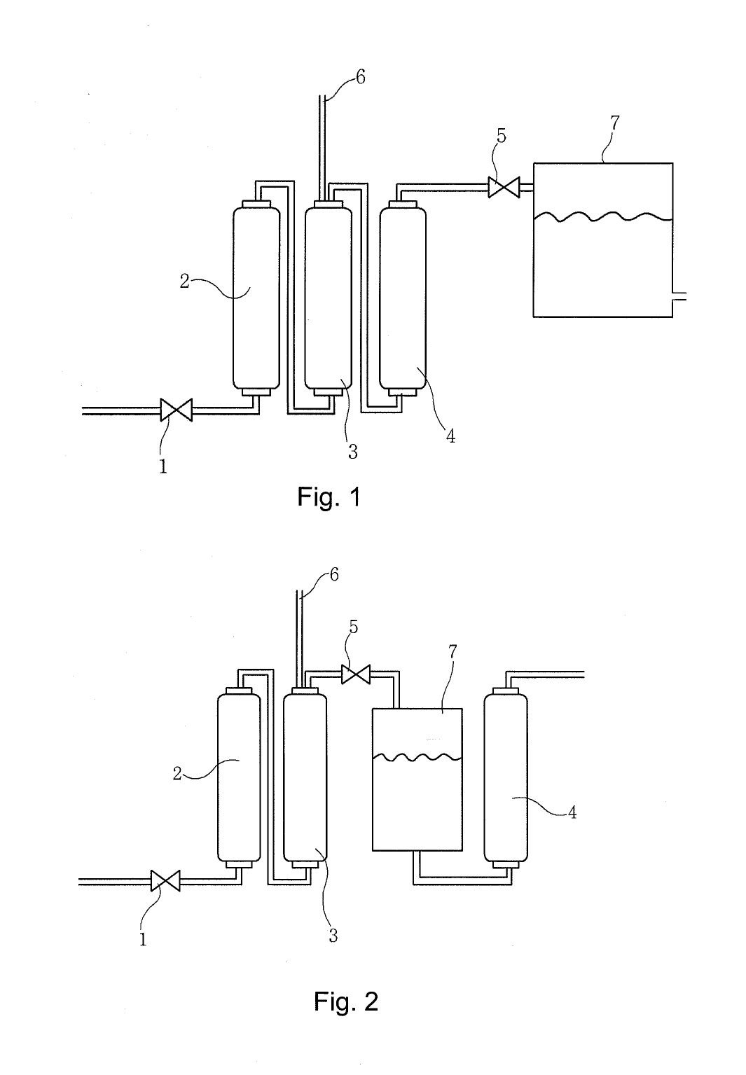

Referring to FIG. 1 illustrating a preferred embodiment of the present invention, the reverse osmosis water purifier is fed with tap water using the tap water pressure or gravity (natural pressure) through an intake valve 1 directly connected with a water pipeline. The filter parts include the sediment filter 2, the chlorine-resistant polyamide composite membrane 3, the post-carbon-filter 4, and the water storage tank 7, all the parts being connected sequentially. The sediment-filter 2 serves to remove suspended solids, sand, rust, moss, and large particles in water, and the chlorine-resistant polyamide composite membrane 3 rejects organic and inorganic pollutants, bacteria, viruses, and ionic compounds including heavy metals from the feed water flowing in from the sediment-filter and remove residual chlorine to some extent, and then, pass a large portion of the residual chlorine to the downstream of the membrane. Wastewater containing solutes rejected by the membrane 3 is discharged through a wastewater pipe 6 which is connected with the vessel containing the chlorine-resistant polyamide composite membrane 3, and the purified water containing a main portion of the chlorine in the feed water flows into the post-carbon-filter 4. The post-carbon-filter 4 serves to remove gas and other substances causing bad smell to improve the taste of water. The purified water continues to flow from the post-carbon filter 4 to a purified-water tank 7, controlling its water level by a water control valve 5, which is located in front of the purified water tank 7.

According to another preferred embodiment of the present invention illustrated in FIG. 2, the reverse osmosis water purifier comprises filter parts consisted of a sediment-filter 2, a chlorine-resistant polyamide composite membrane 3, and a post-carbon filter 4, and a purified-water tank 7 being placed between the chlorine-resistant polyamide composite membrane and the post-carbon filter, the components being connected sequentially and operated by the water pressure or gravity.

The present invention can provide a slim-sized water purifier since the chlorine-resistant polyamide composite membrane makes it possible to omit any pre-carbon-filter, and also supply drinking water of good quality since the chlorine-resistant polyamide composite membrane passes residual chlorine to the rear end portion including the post-carbon-filter and the purified water tank to inhibit an adventitious growth of microorganisms.

Furthermore, the chlorine-resistant polyamide composite membrane applied to the reverse osmosis water purifier of the present invention has high permeate flux and thus it is possible to run the water purifying operation through the tap water pressure and gravity (natural pressure) without using an additional electric pump.

Hereinafter, the preferred embodiments of the present invention will be described in the following examples in more detail.

The embodiments described hereinafter are to be considered as illustrative and not restrictive, and the scope of the present invention is not to be limited to the details given herein.

### Example 1

### A Method of Making Chlorine-Resistant Polyamide Composite Membrane

A porous polysulfone support with thickness of 140 μm, which was previously cast on a non-woven fabric, was immersed in an aqueous solution containing 2% by weight meta-phenylenediamine (MPD) and 0.2% by weight 2-ethyl-1,3-hexanediol (EHD) for 20 seconds. Excess amine solution was removed from the support. The coated support was dipped in an organic solution of 0.1% by weight trimesoylchloride in ISOPAR-C (produced by Exxon) solvent for 40 seconds, The resulting composite membrane was air-dried for 1 minute, and then, washed in 0.2% by weight aqueous solution of sodium carbonate at room temperature for two hours. The resulting polyamide membrane was contacted with 100 ppm dimethylsulfate (DMS) at 225 psi pressure under a basic condition (pH 11) for 30 minutes.

The chlorine-resistant polyamide composite membrane was rolled into a spiral wound module having a diameter of 1.8 inch and an effective membrane area of 4.8 ft².

### Example 2

### A Method of Making Regular Polyamide Composite Membrane

A regular polyamide composite membrane was made in the same way as Example 1, except that the membrane was not treated with dimethylsulfate.

Filter Configuration I

As shown in FIG. 1, the reverse osmosis water purifier according to the present invention comprise filter parts consisted of a sediment-filter, a chlorine-resistant polyamide composite membrane, and a post-carbon filter, being connected sequentially.

Filter Configuration II

As shown in FIG. 2, the reverse osmosis water purifier according to the present invention comprises filter parts consisted of a sediment-filter, a chlorine-resistant polyamide composite membrane, a purified-water tank and a post-carbon filter, being connected sequentially.

Comparative Filter Configuration I

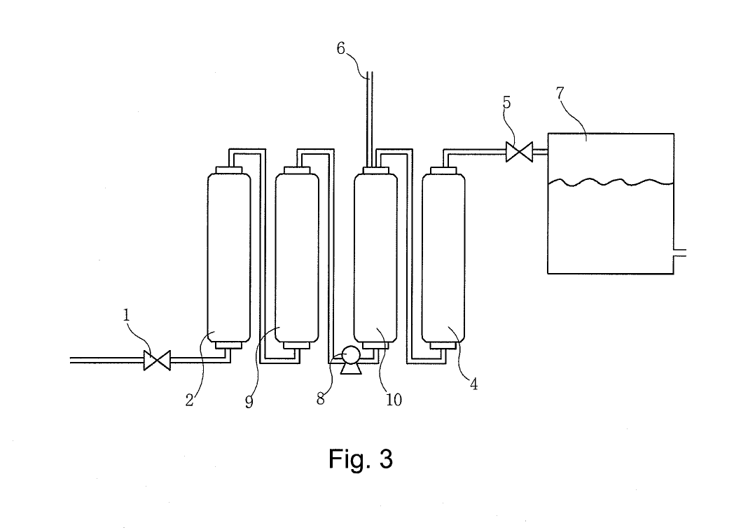

As shown in FIG. 3, the reverse osmosis water purifier represents a typical conventional water purifier comprising filter parts consisted of a sediment-filter, a pre-carbon-filter, a pressure pump, a regular polyamide composite membrane, and a post-carbon filter, being connected sequentially.

Comparative Filter Configuration II

The filter configuration is the same as Filter Configuration I, except that a regular polyamide composite membrane is placed instead of the chlorine-resistant polyamide composite membrane.

Comparative Filter Configuration III

The filter configuration is the same as the Comparative Filter Configuration I, except that the pressure pump is excluded from the reverse osmosis water purifier

Measurement of Residual Chlorine Content

In Filter Configurations I and II and Comparative Filter Configurations I and II, a residual chlorine content was measured at the rear end of each filter part. The chlorine concentration in the feed water was 0.5 ppm and the conductivity of the feed water is 250±5 uS/cm at room temperature. The percentage of the residual chlorine content relative to that of the feed water right after each filter is shown in Table I below.

TABLE I

| | | | | Comparative |
|---|---|---|---|---|
| | Filter | Filter | Comparative | Filter |
| | Config- | Configuration | Filter | Configuration |
| | uration I | II | Configuration I | II |
| Sediment- | 93% | 94% | 91% | 92% |
| filter | | | | |
| Pre- | — | — | 2% | — |
| carbon- | | | | |
| filter | | | | |
| Polyamide | 67% | 66% | 0% | 75% |
| composite | | | | |
| membrane | | | | |
| Post- | 0% | 0% | 0% | 0% |
| carbon- | | | | |
| filter | | | | |

As shown in Table I, the relative chlorine content of Filter Configuration I and II right after the polyamide membrane is 67% and 66% respectively, while in Comparative Filter Configuration I, the relative chlorine content after the pre-carbon filter is 2%, indicating most of chlorine is adsorbed by the carbon filter, and obviously, the relative chlorine content after the polyamide membrane is zero.

Measurement of Desalination Efficiency

The reverse osmosis water purifiers of the Filter Configurations I and II and the Comparative Filter Configurations I and II were operated at 38±2 psi pressure using tap water, containing 0.5 ppm residual chlorine and total dissolved solutes (TDS) of 250±5 uS/cm measured in conductivity at room temperature. The reverse osmosis water purifiers were operated for 60 days in an intermittent operation mode of 12-hour continuous operation followed by 12-hour shut down. The initial and final desalination efficiencies were measured shown in Table II.

TABLE II

| | Initial | Desalination |
|---|---|---|
| | desalination | efficiency after 60 |
| | efficiency | days |
| Filter Configuration I | 95.4% | 96.6% |
| Filter Configuration | 95.7% | 96.8% |
| II | | |
| Comparative Filter | 95.6% | 95.0% |
| Configuration I | | |
| Comparative Filter | 95.3% | 80.1% |
| Configuration II | | |

As shown in Table II, Filter Configurations I and II, equipped with the chlorine-resistant polyamide composite membrane exhibits virtually no change in desalination efficiency after exposure to chlorine for 60 days.

On the other hand, in the case of Comparative Filter Configuration II, having a regular polyamide composite membrane without a pre-carbon filter, the desalination efficiency dropped sharply from the initial desalination efficiency of 95.3% to 80% after 60 days under the same condition, indicating the polyamide composite membrane was damaged by chlorine.

Measurement of Permeate Flux

The reverse osmosis water purifiers of Filter Configurations I and II and the Comparative Filter Configurations II and III were operated at 38±2 psi pressure using tap water, containing 0.5 ppm chlorine and TDS of 250−5 uS/cm in conductivity at room temperature. The reverse osmosis water purifiers were operated for 60 days in an intermittent operation mode of 12-hour continuous operation followed by 12-hour shut down. The final permeate flux was measured and the results are shown in Table III.

TABLE III

| | Initial Permeate | Permeate flux |
|---|---|---|
| | flux | after 60 days |
| Filter Configuration I | 11.0 GFD | 10.5 GFD |
| Filter Configuration | 11.1 GFD | 10.7 GFD |
| II | | |
| Comparative Filter | 4.2 GFD | 12.6 GFD |
| Configuration II | | |
| Comparative Filter | 4.1 GFD | 4.0 GFD |
| Configuration III | | |

As shown in Table III, Filter Configurations I and II, produced the initial permeate flux of 11.0 GFD and 11.1 GFD, respectively. The flux is more than 2 times higher than the Comparative Filter Configurations II and III. The permeate flux of Filter Configurations I and II is slightly lowered after operation for 60 days. This high flux allows Filter Configurations I and II to produce sufficient permeate water without a pump.

On the other hand, the Comparative Filter Configuration II, wherein a regular polyamide composite membrane is mounted in place of the chlorine-resistant polyamide composite membrane, shows low initial permeable flux of 4.2 GFD and higher final flux of 12.6 GFD, indicating the membrane is damaged by chlorine to show higher flux after 60 days since the Comparative Filter Configuration 2 does not have a pre-carbon filter. The Comparative Filter Configuration III, wherein the pressure pump is excluded from the Comparative Filter Configuration I, shows a low initial flux of 4.1 GFD which remains unchanged for 60 days.

Since the regular polyamide composite membranes used in the Comparative Filter Configurations II and III has low permeate flux, reverse osmosis water purifiers having the regular polyamide composite membranes have to use a pressure pump to increase the feed water pressure.

On the other hand, since the chlorine-resistant polyamide composite membrane used in Filter Configurations I and II has sufficient permeate flux at the tap water pressure, a reverse osmosis water purifier having the chlorine-resistant polyamide composite membrane does not need a pressure pump, thereby reducing the operation costs.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A reverse osmosis water purifier having a simple filter configuration, said reverse osmosis water purifier comprising filter parts consisted of a sediment-filter;
a chlorine-resistant polyamide composite membrane; and
a post-carbon-filter;
wherein the chlorine-resistant polyamide composite membrane does not require a pre-carbon filter to remove chlorine to protect said membrane from chlorine attack, thereby the omission of a pre-carbon filter allowing a simpler filter configuration than an existing reverse osmosis water purifier.

2. The reverse osmosis water purifier according to claim 1, said reverse osmosis water purifier comprising filter parts, being consisted of a sediment-filter; a chlorine-resistant polyamide composite membrane; and a post-carbon filter, and a water storage tank connected sequentially.

3. The reverse osmosis water purifier according to claim 1, said reverse osmosis water purifier comprising filter parts, being consisted of a sediment-filter; a chlorine-resistant polyamide composite membrane; and a post-carbon-filter, and a water storage tank,
wherein said storage tank is placed between said chlorine-resistant polyamide composite membrane and said post-carbon-filter.

4. The reverse osmosis water purifier according to claim 1, the chlorine-resistant polyamide composite membrane is made by alkylating a conventional polyamide membrane using an alkylating agent.

5. The reverse osmosis water purifier according to claim 4, the alkylating agent is at least one selected from the group consisted of dimethylsulfate, methyl iodide, methyl bromide, ethyl iodide, ethyl bromide, propyl iodide, propyl bromide, allyl iodide, allyl bromide, allyl chloride, ethylene diiodide, ethylene dibromide trimethylene diiodide, and trimethylene dibromide.

6. The reverse osmosis water purifier according to claim 1, the chlorine-resistant polyamide composite membrane exhibits chlorine resistance to keep a desalination efficiency of at least 85% when it is exposed to a sodium hypochlorite (NaOCl) concentration ranging from 500 ppm to 2,000 ppm for one hour to 24 hours

7. The reverse osmosis water purifier according to claim 1, the permeate flux of the chlorine-resistant polyamide composite membrane is 10 GFD or more when said chlorine-resistant polyamide composite membrane is tested using 250 ppm of NaCl at 60 psi.

8. The reverse osmosis water purifier according to claim 1, the chlorine-resistant polyamide composite membrane passes 20% or more of residual chlorine in the feed water to the downstream of the chlorine-resistant membrane.
